(19) United States
(12) Patent Application Publication
(10) Pub. No.: US 2006/0294097 A1
(43) Pub. Date: Dec. 28, 2006

(54) System, method and computer program product for locating a subset of computers on a network

(75) Inventor: Ryan S. Russell, Hillsboro, OR (US)

Correspondence Address: Zilka-Kotab, PC, P.O. BOX 721120, SAN JOSE, CA, 95172-1120, US

(73) Assignee: MCAFEE, INC.

(21) Appl. No.: 11/168,241

(22) Filed: Jun. 27, 2005

(51) Int. Cl. G06F 17/30

(52) U.S. Cl. 707/6

(57) ABSTRACT

A system, method and computer program product are provided for computer management. Initially, a plurality of categories associated with computers on a network is provided. In addition, the plurality of categories each includes a plurality of values. In use, at least one of the values is received, and a subset of the computers is outputted based on the received at least one value.

### FIELD OF THE INVENTION

The present invention relates to computer management software, and more particularly to identifying computers on a network.

### BACKGROUND

Management systems have typically been provided for managing data associated with certain categories of objects. One example of management systems is management products that manage software. Such products generally enable users to manage software (e.g. installation, updates, etc.) with respect to specific computers. Another example of current management systems includes network management products. Typically, network management products enable users to manage and monitor information that is sent over a computer network. Of course, there are many other types of management systems utilized for managing various categories of objects.

Although there are numerous types of management systems, traditional types of management systems that manage computers on a network do not provide users with an easy way to find a computer or group of computers within a network. Such systems are static, inflexible, and/or require complex logical expressions for locating a computer on a network.

A first type of traditional computer management systems are those in which a tree structure containing all computers on a network is utilized. Since a tree structure requires a user to search through the tree to locate a specific computer, such structure results in an extremely tedious and time consuming process, especially in a system that manages hundreds or even thousands of computers.

Additionally, the tree structure requires users to remember the hierarchy and structure of the tree in order to backtrack to find computers that have been overlooked on a first pass through the tree. In general, users simply do not have sufficient time to spend searching through such a system. Another problem inherent in the tree structure management system is that the tree structure is fixed. Thus, users are incapable of dynamically adjusting the hierarchy of computers to tailor it to their needs.

A second type of traditional computer management system includes those in which a user must develop a programming statement in order to search through a database of computers. Such systems have typically required complex logical statements in order to locate a computer or group of computers within the database. Users must create new statements for each computer or group of computers they wish to locate, and with the inescapable complexity of the statements that must be used, such a system is generally very time-consuming.

Furthermore, the type of systems which employ programming statements is far from user-friendly. Specifically, they require users to understand the structure of the database holding all of the information on the computers, such as the field values, for example. They also require users to understand Boolean logic well enough to create the complex statements. In today's work environment, users do not have the time to spend using this type of complex system.

The inflexibility and static nature of current computer management systems, as described above in the form of a few examples, simply do not meet the needs of today's ever-changing corporate environments. Especially when considering the large number of computers capable of being located on today's networks along with the large number of computers actually utilized on networks in current networking environments, it is clear that such computer management systems are insufficient. In addition, such systems are not meeting the fast paced nature of corporate environments, but instead are slowing down the management of computers on networks by requiring unnecessary amounts of manual work.

There is thus a need for overcoming these and/or other problems associated with the prior art.

### SUMMARY

A system, method and computer program product are provided for computer management. Initially, a plurality of categories associated with computers on a network is provided. In addition, the plurality of categories each includes a plurality of values. In use, at least one of the values is received, and a subset of the computers is outputted (e.g. displayed, etc.) based on the received at least one value.

In one aspect of the present embodiment, the displaying may include displaying information associated with each computer in the subset of computers. In addition, the present embodiment may further comprise selecting at least one of the computers in the displayed subset of computers and initiating an action on the selected at least one computer.

In another aspect of the present embodiment, the categories may include a geography category, a business unit category, a computer type category, an operating system category, an installed software category and/or a security traits category. The geography category may further include an America value and/or an Asia Pacific value. The computer type category may include a desktop value, an exchange server value, a file server value and/or a laptop value.

In still yet another aspect of the present embodiment, the receiving may comprise identifying at least one category and selecting at least one value for each of the at least one category. As an option, the at least one selected value for each of the at least one category may be capable of being de-selected.

In another aspect of the present embodiment, a query may be run against a database including data relating to the computers corresponding to the plurality of values, in response to the receipt of the at least one value. Additionally, a master statement may be created in response to the receipt of a plurality of the values, where the master statement may include a combination of the queries reflecting each of the plurality of the values.

An additional query may also be run against the subset of the computers, in response to the receipt of an additional value. As another option, the displaying may be updated based on results of the additional query. Further, one of the queries associated with a de-selected value may be removed from a master statement.

### BRIEF DESCRIPTION OF THE DRAWINGS

FIG. 1 illustrates a network architecture, in accordance with one embodiment.

FIG. 2 shows a representative hardware environment that may be associated with the data server computers and/or end user computers of FIG. 1, in accordance with one embodiment.

FIG. 3 shows a method for locating a subset of computers on a network, in accordance with one embodiment.

FIG. 4 shows a method for locating a subset of computers on a network, in accordance with another embodiment.

FIG. 5 shows a graphical user interface for locating at least one computer on a network, in accordance with still yet another embodiment.

### DETAILED DESCRIPTION

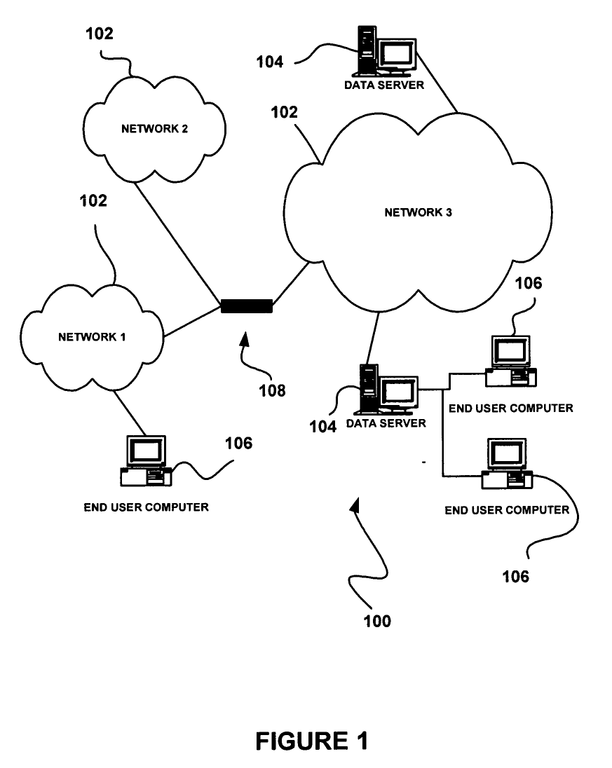

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, etc.

Coupled to the networks 102 are data server computers 104 which are capable of communicating over the networks 102. Also coupled to the networks 102 and the data server computers 104 is a plurality of end user computers 106. Such data server computers 104 and/or client computers 106 may each include a desktop computer, lap-top computer, hand-held computer, mobile phone, hand-held computer, peripheral (e.g. printer, etc.), any component of a computer, and/or any other type of logic. In order to facilitate communication among the networks 102, at least one gateway or router 108 is optionally coupled therebetween.

It should be noted that any of the foregoing network devices in the present network architecture 100, as well as any other unillustrated hardware and/or software, may be equipped with various computer management features. For example, the various data server computers 104 and/or end user computers 106 may be equipped with computer management hardware and/or software for identifying the various computers on any of the networks 102. More information regarding optional functionality and optional architectural components associated with such feature will now be set forth for illustrative purposes.

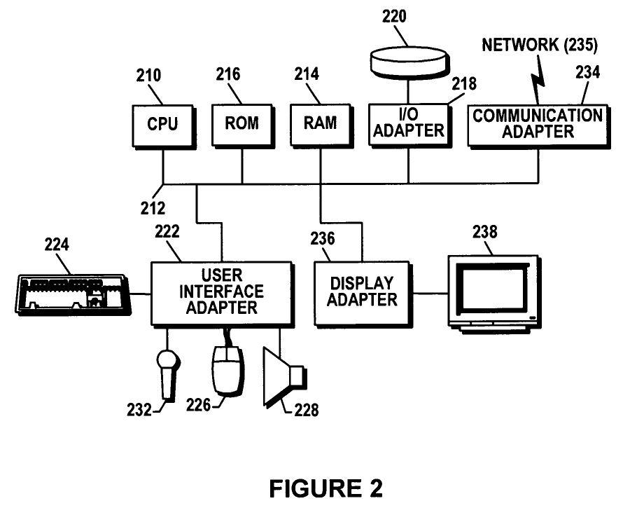

FIG. 2 shows a representative hardware environment that may be associated with the data server computers 104 and/or end user computers 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Our course, the various embodiments set forth herein may be implemented utilizing hardware, software, or any desired combination thereof. For that matter, any type of logic may be utilized which is capable of implementing the various functionality set forth herein.

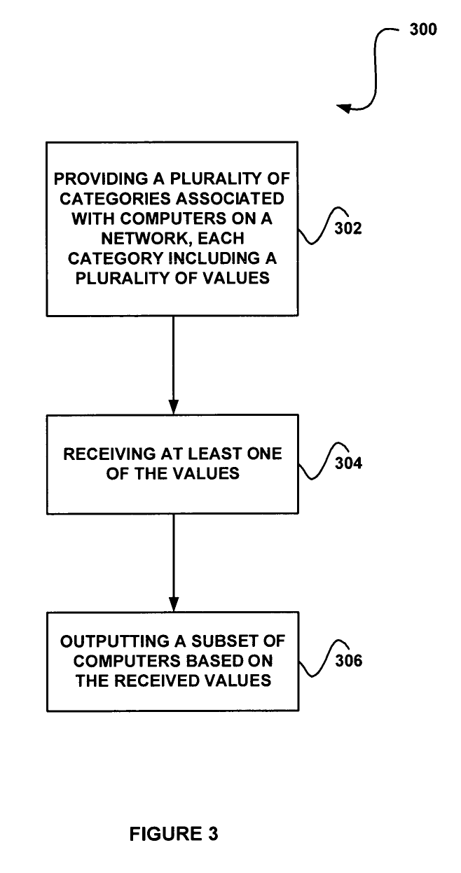

FIG. 3 shows a method 300 for locating a subset of computers on a network, in accordance with one embodiment. As an option, the present method 300 may be implemented in the context of the architecture and environment of FIGS. 1 and/or 2. Of course, however, the method 300 may be carried out in any desired environment.

Initially, a plurality of categories associated with computers on a network is provided, where each category includes a plurality of values. See operation 302. In the context of the present description, the computers may include any device (e.g. see, for example, the data server computers 104 and/or end user computers 106 of FIG. 1, etc.). Furthermore, the network may include any network capable of networking computers. One such network, for example, may include the network, as depicted in FIG. 1.

The categories may optionally include a geography category, a business unit category, a computer type category, an operating system category, an installed software category, a security traits category, a filter string category, a virus scan category, etc. Of course, this list of categories is set forth for illustrative purposes only and should not be construed as limiting in any manner. For example, any of such categories may be omitted, and any other category may be utilized which is capable of being associated with at least one computer on the network.

The values included with respect to each category may include any values capable of being associated with a category. For example, the values included in the geography category may include an America value, an Asia Pacific value, a Europe value, a Middle Eastern value, an Africa value, or any other value associated with geography (e.g. any city value, state value, company division value, etc.). Table 1 illustrates values that may each be associated with a category, in the context of the present method 300.

TABLE 1

| CATEGORY | Value1 | Value2 | Value3 | Value4 |
|---|---|---|---|---|
| Geography | America | Asia Pacific | Europe, Middle East | . . . |
| | | | and Africa | |
| Computer | Desktop | Exchange | File Server | Laptop |
| Type | | Server | | |

Of course Table 1 in provided for illustration only, and should not to be construed as limiting the present method to specific categories and values as depicted above. In one embodiment, the plurality of categories and associated values above may be provided as default categories and values. To this end, in the context of the present description, the term “value” is not limited to any numerical connotation, but rather may include anything that can be categorized within one of the categories.

As an option, the plurality of categories and associated values may be customized by utilizing a system that monitors all computers on a network. For example, agents may collect data on each computer on the network and send the data to a system that collects and analyzes the data. Then, a database may be created that includes all of the monitored computers and their associated data. Subsequently, the system may create and store categories and associated values based on the gathered information. Of course, the foregoing process may be repeated, as desired. One example of such a system for collecting the data may include the McAfee® ePolicy Orchestrator™. In this way, the database of computers searched by a user is up-to-date.

As an alternative, the plurality of categories and associated values may be manually created. Of course, the plurality of categories and associated values may be provided in any desired manner for identification purposes.

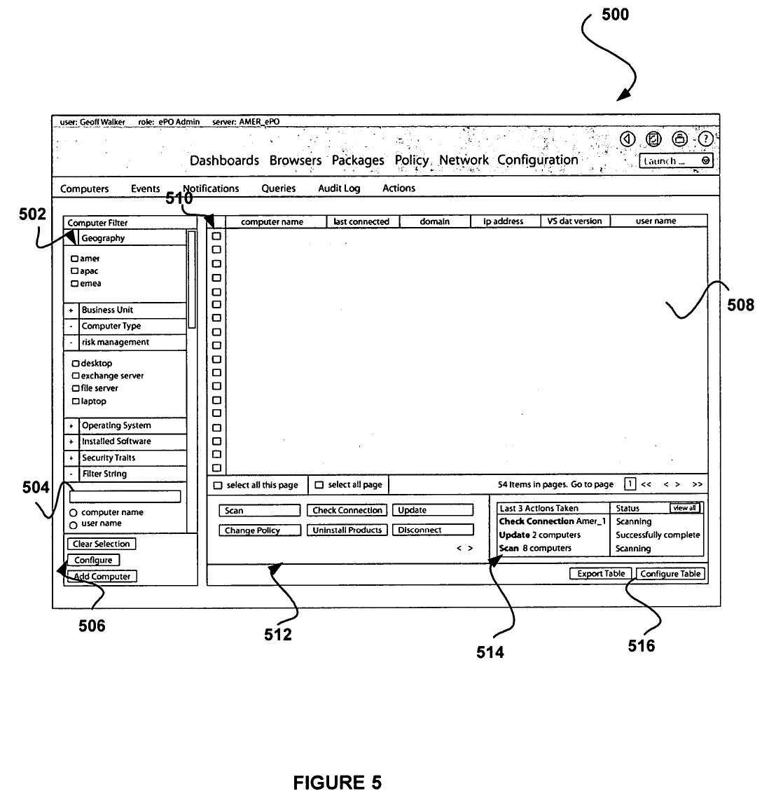

After the plurality of categories and associated values are provided in operation 302, at least one of the values is received, as depicted in operation 304. The values may include any of the values described with respect to operation 302, but, of course, any values may be utilized. The values may be received, in one optional embodiment, by first identifying at least one category and then selecting at least one value for each category. Further, the value(s) may be received by way of a graphical user interface (GUI), an example of which will be described in more detail with respect to FIG. 5. Of course, any manual and/or automated manner of receiving such values may be utilized.

Still yet, the value(s) that are received in operation 304 may be received by utilizing an input device. Such input device may include a network (e.g. see, for example, the network(s) 102 of FIG. 1, etc.), a computer (e.g. see, for example, the data server computers 104 and/or end user computers 106 of FIG. 1, etc.) or component(s) thereof, and/or any other input device capable of allowing data to be received.

Next, in operation 306, a subset of the computers is outputted based on the received value(s) of operation 304. The subset of computers may include a single computer located on the network, or multiple computers located on the network. Furthermore, the subset may, include only the computers that correspond to the value(s) provided in operation 304. For example, if Computer#1 is located in America and is a laptop, then Computer#1 would be displayed if the values received in operation 304 included an America value and a laptop value. In another embodiment, Computer#1 may be displayed if the value(s) received in operation 304 included either an America value or a laptop value.

In use, the subset of the computers may be outputted utilizing a GUI. Again, an example of such a GUI will be described in more detail with respect to FIG. 5. Of course, any type of output device such a network (e.g. see, for example, the network(s) 102 of FIG. 1, etc.), a computer (e.g. see, for example, the data server computers 104 and/or end user computers 106 of FIG. 1, etc.) or component(s) thereof, and/or any other output device capable of outputting data.

More illustrative information will now be set forth regarding various optional architectures and features with which the foregoing method 300 may or may not be implemented, per the desires of the user. It should be strongly noted that the following information is set forth for illustrative purposes and should not be construed as limiting in any manner. Any of the following features may be optionally incorporated with or without the exclusion of other features described.

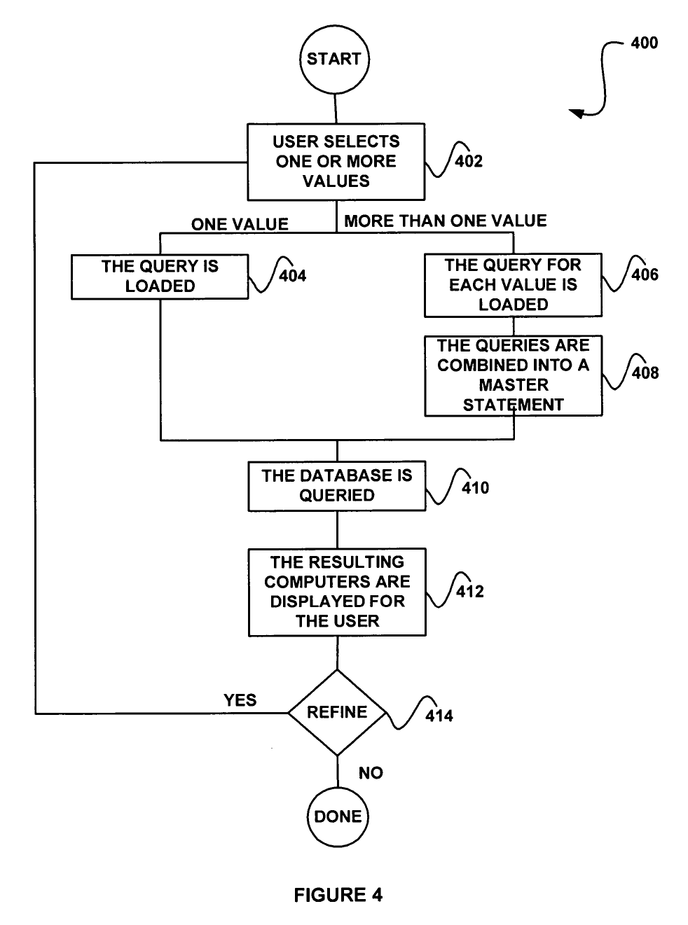

FIG. 4 shows a method 400 for locating a subset of computers on a network, in accordance with another embodiment. As an option, the present method 400 may be implemented in the context of the architecture and environment of FIGS. 1-3. Of course, however, the method 400 may be carried out in any desired environment. In addition, the definitions referred to with respect to FIG. 3 also apply in the context of method 400.

Initially, a user selects at least one value, as in operation 402. Again, such value may be any value associated with a category. The user may optionally select a single value within a single category, or may select multiple values within the same or different categories.

If a single value is selected in operation 402, a query is loaded with the single value, as shown in operation 404. The query may include any query engine capable of receiving an input and retrieving data from a database based on the input. For example, such query may include an SQL query utilizing the Microsoft® SQL Server.

If more than one value is selected in operation 402, a query is loaded for each value, as shown in operation 406. Next, in operation 408, the loaded queries are combined to form a master statement. The master statement may include any logical statement which incorporates the values selected in operation 402 and which is capable of retrieving data in a database associated with the selected values of operation 402. Specifically, the master statement may include Boolean logic (e.g. AND/OR operators, etc.) for combining the queries loaded in operation 406.

After either the query is loaded in operation 404 or the master statement is created in operation 408, a database is then queried utilizing the same, as shown in operation 410. Such database may include any database that holds data corresponding to the provided categories and values, such as those with respect to operation 302 of FIG. 3, for each of the computers on a network. For example, the database may include a table with each row corresponding to a specific computer and each associated column including only the data that corresponds to that specific computer.

The results of the query are then displayed to the user, as in operation 412. The results may include the computers retrieved from the database with respect to the query of operation 404 or the master statement of operation 408. The results may further include any additional information associated with each of the retrieved computers. Thus, in this way, a user is able to locate a computer by merely selecting criteria specific to that computer. For example, if a user desires to locate all computers on a network that have not been scanned for viruses within a predefined time period, the user may select a virus scan value, a query may be run with that virus scan value, and only computers that meet the selected virus scan value are returned.

As shown in operation 414, if the user is not satisfied with the results displayed in operation 412, or if the user simply desires to run another search, the user may refine the selected values by returning to operation 402. The selected values may be refined by de-selecting any values no longer needed and/or by selecting additional values. When a user decides to refine a search in operation 414, only the queries affected by the refined search are either added or deleted. Thus, time and memory is saved by merely modifying and re-using the original query.

For example, if a user decides to de-select a laptop value included in a previous master statement, only the query associated with the laptop value is removed from the original master statement, and the modified master statement is run. In addition, if a new value is selected, only the additional query may be run against the original displayed results (i.e. subset of computers) of operation 412. Thus, in this manner, increased performance may be provided. After the search has been refined, only the updated results may be displayed based on the refined values. In this way, a user may repeatedly refine a search by selecting additional values and de-selecting already-selected values.

By utilizing categories and values that a user may select, such as described with respect to FIG. 4, a user-friendly system of locating a subset of computers on a network is provided. More information will now be set forth regarding an exemplary user interface which may be used in the context of the foregoing technique(s).

FIG. 5 shows a GUI 500 for locating at least one computer on a network, in accordance with still yet another embodiment. As an option, the present GUI 500 may be implemented in the context of the architecture and environment of FIGS. 1-4. Of course, however, the GUI 500 may be carried out in any desired environment.

The GUI 500 includes a computer filter section 502 that lists all categories capable of being identified by a user. The categories may be identified by the user by selecting the category name or expand button next to the category. Once the category is identified, the category may be expanded to show the values included in the category. After the values are expanded, a user may then select any of the values. For example, such values may be selected by checking a box next to the value.

The GUI 500 also includes a field 504 in which a user can search for a specific computer by name and/or by user. Thus, the user is capable of typing in a computer name and/or user name to locate a specific computer on the network of computers. Of course, the user may type in a name in addition to selecting additional values in order to locate a computer. As an option, the user may only type in part of a name to locate all computers that contain the part of the name entered by the user. Further included in the GUI 500 are options 506 for clearing all selected values at one time and configuring the categories displayed in the computer filter section 502. For example, if a configure option is selected, a new window is displayed that allows a user to choose from numerous categories. Thus, the user can customize the types of categories displayed in the GUI 500 as needed.

In addition, the GUI 500 includes a display area 508 for displaying the subset of computers output from the user's search criteria. Each row is capable of displaying a computer name and any additional information associated with the computer. For example, in the present embodiment, the last connection, the domain, the IP address and virus scan signature version, and the user name associated with each computer are displayed. However, any type of information may be displayed that is associated with a computer included in the subset of computers. Also, check boxes 510 may be included for selecting any number of the computers displayed in the display area 508.

As an option, the computers displayed in the display area 508 may each be capable of being selected. For example, if the first row of the display area 508 lists “Computer1” with associated information, a user may select (e.g. click on, etc.) “Computer1”. Such selection may allow an additional, unillustrated GUI to be displayed which includes any or all information associated with the computer. Of course, any such information may be displayed accordingly, and may optionally be configured by a user.

Still yet, the GUI 500 may include an action area 512. The action area 512 may allow a user to perform specific actions on a computer(s) selected from the display area 508. The actions may include performing a virus scan on the computer, checking a network connection to the computer, updating the computer, changing a policy on the computer, uninstalling hardware and/or software on the computer, disconnecting the computer from the network, and/or any other action capable of being performed on a computer. As shown, the action area 512 may include arrows for scrolling through the action area 512 such that other actions not visible within the limits of the action area 512 may be viewed and selected by a user. Optionally, a user may select multiple computers from the display area 508 and may then select any action(s) to perform on the multiple selected computers.

A status area 514 may also be included in the GUI 500. The status area 514 may display any action taken on a selected computer(s) and the status of such action. For example, if a user selects multiple actions to be taken on a specific computer, the status area 514 may show any selected actions and the status (e.g. checking, scanning, successfully completed, unsuccessful, etc.) of each selected action. Still yet, the GUI 500 may incorporate export and configure table options 516. Such options 516 may allow a user to export the information in the display area 508 and/or configure the information displayed in the display area 508. Thus, users have wide capabilities to customize the GUI 500 to meet their individual needs.

Accordingly, the GUI 500 creates an extremely flexible system. Specifically, the GUI 500 allows a user to customize search options, display options and action options per the desires of the user.

While various embodiments have been described above, it should be understood that they have been presented by way of example only, and not limitation. For example, any of the network elements may employ any of the desired functionality set forth hereinabove. Thus, the breadth and scope of a preferred embodiment should not be limited by any of the above-described exemplary embodiments, but should be defined only in accordance with the following claims and their equivalents.

What is claimed is:

1. A method, comprising:
providing a plurality of categories associated with computers on a network, each category including a plurality of values;
receiving at least one of the values, utilizing an input device; and
displaying a subset of the computers based on the received at least one value, utilizing an output device.

2. The method of claim 1, wherein the displaying includes displaying information associated with each computer in the subset of computers.

3. The method of claim 1, further comprising selecting at least one of the computers in the displayed subset of computers and initiating an action on the selected at least one computer.

4. The method of claim 1, wherein the categories include a geography category.

5. The method of claim 1, wherein the categories include a business unit category.

6. The method of claim 1, wherein the categories include a computer type category.

7. The method of claim 1, wherein the categories include an operating system category.

8. The method of claim 1, wherein the categories include an installed software category.

9. The method of claim 1, wherein the categories include a security traits category.

10. The method of claim 4, wherein the geography category includes an America value.

11. The method of claim 4, wherein the geography category includes an Asia Pacific value.

12. The method of claim 6, wherein the computer type category includes a desktop value.

13. The method of claim 6, wherein the computer type category includes an exchange server value.

14. The method of claim 6, wherein the computer type category includes a file server value.

15. The method of claim 6, wherein the computer type category includes a laptop value.

16. The method of claim 1, wherein the receiving further comprises:
identifying at least one category, and
selecting at least one value for each of the at least one category.

17. The method of claim 16, wherein the at least one selected value for each of the at least one category is capable of being de-selected.

18. The method of claim 1, wherein a query is run against a database including data relating to the computers corresponding to the plurality of values, in response to the receipt of the at least one value.

19. The method of claim 18, wherein a master statement is created in response to the receipt of a plurality of the values, where the master statement includes a combination of the queries reflecting each of the plurality of the values.

20. The method of claim 18, wherein an additional query is run against the subset of the computers, in response to the receipt of an additional value.

21. The method of claim 20, wherein the displaying is updated based on results of the additional query.

22. The method of claim 19, wherein one of the queries associated with a de-selected value is removed from the master statement.

23. The method of claim 1, wherein a graphical user interface is utilized for the displaying and receiving.

24. A computer program product embodied on a computer readable medium, comprising:
computer code for storing a plurality of categories associated with computers on a network, each category including a plurality of values;
computer code for identifying at least one of the values; and
computer code for outputting a subset of the computers based on the received at least one value.

25. A system, comprising:
memory in communication with a processor for storing a plurality of categories associated with computers on a network, each category including a plurality of values;
an input device in communication with the processor, the input device for receiving at least one of the values; and
an output device in communication with the processor, the output device for outputting a subset of the computers based on the received at least one value.
